(19) United States
(12) Patent Application Publication
(10) Pub. No.: US 2010/0103598 A1
(43) Pub. Date: Apr. 29, 2010

(54) Electronic apparatus and method for the same

(75) Inventor: Masataka Sakata, Kobe (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/588,540

(22) Filed: Oct. 19, 2009

(30) Foreign Application Priority Data
Oct. 24, 2008 (JP) 2008-274396
Oct. 24, 2008 (JP) 2008-274416

(51) Int. Cl. H05K 7/00

(52) U.S. Cl. 361/679.01

(57) ABSTRACT

An electronic apparatus includes: a main portion; an electronic device which covers a front face of the main portion, and which moves with respect to the main portion to expose the front face of the main portion; a flexible substrate which is connected between a rear face of the electronic device and the main portion, and which transmits a signal; and a frame which is provided at the front face of the main portion to house at least a part of the electronic device when the electronic device covers the front face of the main portion, and in which a lower portion having a projection amount greater than that of an upper portion from the front face of the main portion, and which has a cutout portion which is lower than a position where the flexible substrate is connected to the front face of the main portion.

### CROSS-REFERENCE TO RELATED APPLICATION

This application is based upon and claims the benefit of priority of the prior Japanese Patent Application No. 2008-274396 filed on Oct. 24, 2008 and Japanese Patent Application No. 2008-274416 filed on Oct. 24, 2008, the entire contents of which are incorporated herein by reference.

### FIELD

The present invention relates to an electronic apparatus and a method of producing the same, and in particular, to an electronic apparatus including an electronic device and a main portion and a method of producing the same.

### BACKGROUND

For example, an in-vehicle navigation apparatus mounted in the vehicle is generally arranged in a dashboard between a driver's seat and a passenger's seat, and its size, when viewed from its front, has to be a specified size. Thus, there is known a structure in which a display portion (electronic device) and a main portion are provided. When the display portion is watched, a back face of the display portion faces a front face of the main portion. When a storage medium is inserted into and ejected from an insertion and ejection slot provided on the front face of the main portion, the display portion is tilted. Further, there is a structure in which a frame is provided for surrounding the front face of the main portion to house the display portion.

Japanese Unexamined Patent Publication No. 2006-75460 describes a mobile phone in which a bracket for securing a hinge portion is provided with a cutout portion for avoiding the interference with a flexible cable.

Japanese Unexamined Patent Publication No. 2007-158236 also describes a dowel for supporting a shelf. This dowel for supporting the shelf is reciprocated by a rotational operation thereof, with respect to a dowel support which is secured by knocking into a pilot hole provided in a side wall of a piece of furniture or the like.

In the electronic apparatus mentioned above, for example, a lower portion of the flame may be projected than an upper portion thereof so as to match the shape of the dashboard on which the electronic apparatus is mounted. In this case, a flexible substrate has to be made long in order to connect the flexible substrate, which is connected with the display portion, to the front face of the main portion in the manufacturing process, because the lower portion is greatly projected. On the other hand, when the flexible substrate is long, the display portion is intervened by the flexible substrate when tilted. For example, noises are generated, when the flexible substrate is fractioned by the main portion or the display portion.

As described above, in the electronic apparatus in which the display portion (electronic device) and the main portion are connected by the flexible substrate, the display portion tilts to move its lower portion away from the main portion, and the lower portion of the frame is projected than the upper portion thereof, there is a problem that the manufacturing process becomes difficult when the flexible substrate is made shorter.

Additionally, in a case where a cutout portion is provided in the frame, it is not preferable to keep the cutout portion unchanged in consideration of the appearance of the frame. Thus, to improve the appearance of the frame, a member matching a shape of the cutout portion is fitted into the cutout portion. In this case, the appearance is further improved, when the member is fitted into the cutout portion not to generate a step in the fitting portion of the frame and the member.

However, there is a problem that it is difficult to precisely manufacture such a member.

### SUMMARY

It is therefore an object of the present invention to provide an apparatus and a method for producing the same, thereby producing the electronic apparatus with ease, or thereby improving an appearance of a frame with ease.

According to an aspect of the present invention, there is provided an electronic apparatus including: a main portion; an electronic device which covers a front face of the main portion, and which moves with respect to the main portion to expose the front face of the main portion; a flexible substrate which is connected between a rear face of the electronic device and the main portion, and which transmits a signal; and a frame which is provided at the front face of the main portion to house at least a part of the electronic device when the electronic device covers the front face of the main portion, and in which a lower portion having a projection amount greater than that of an upper portion from the front face of the main portion, and which has a cutout portion which is lower than a position where the flexible substrate is connected to the front face of the main portion. With the present configuration, the electronic apparatus can be produced with ease by connecting the flexible substrate to the main portion via the cutout portion.

According to another aspect of the present invention, there is provided a method for producing an electronic apparatus including: a main portion; an electronic device which covers a front face of the main portion, and which moves with respect to the main portion to expose the front face of the main portion; a flexible substrate which is connected between a rear face of the electronic device and the main portion, and which transmits a signal; and a frame which is provided at the front face of the main portion to house at least a part of the electronic device when the electronic device covers the front face of the main portion, and in which a lower portion having a projection amount greater than that of an upper portion from the front face of the main portion, and which has a cutout portion which is lower than a position where the flexible substrate is connected to the front face of the main portion. The method includes a step of connecting the flexible substrate connected to a rear face of the electronic device to a front face of the main portion via the cutout portion. With the present configuration, the electronic apparatus can be produced with ease by connecting the flexible substrate to the main portion via the cutout portion.

According to a further aspect of the present invention, there is provided a method for producing an electronic apparatus including: a main portion; an electronic device which covers a front face of the main portion, and which moves with respect to the main portion to expose the front face of the main portion; a flexible substrate that is connected between a rear face of the electronic device and the main portion, and which transmits a signal; a frame which is provided at the front face of the main portion to house at least a part of the electronic device when the electronic device covers the front face of the main portion, and in which a lower portion having a projection amount greater than that of an upper portion from the front face of the main portion, and which has a cutout portion which is lower than a position where the flexible substrate is connected to the front face of the main portion; and a member which is fitted into the cutout portion. The method includes a step of providing a projection at a surface of the member in contact with the frame. With the present configuration, a step generated in the fitting portion of the frame and the member is adjustable with ease. Accordingly, the appearance of the frame can be improved.

### BRIEF DESCRIPTION OF DRAWINGS

FIG. 1 is a perspective view of an electronic apparatus according to a first embodiment;

FIG. 2 is a perspective view of a main portion according to the first embodiment;

FIGS. 3A and 3B are views of a display portion;

FIGS. 4A and 4B are cross-sectional views of the electronic apparatus;

FIG. 5 is a first perspective view of a method for producing the electronic apparatus;

FIG. 6 is a second perspective view of the method for producing the electronic apparatus;

FIG. 7 is a third perspective view of the method for producing the electronic apparatus;

FIGS. 8A and 8B are schematically cross-sectional views of the method for producing the electronic apparatus;

FIG. 9 is a fourth perspective view of the method for producing the electronic apparatus;

FIG. 10 is a fifth perspective view of the method for producing the electronic apparatus;

FIGS. 11A and 11B are second schematically cross-sectional views of the method for producing the electronic apparatus;

FIG. 12 is a sixth perspective view of the method for producing the electronic apparatus;

FIG. 13 is a third schematically cross-sectional view of the method for producing the electronic apparatus;

FIG. 14 is a schematically cross-sectional view of a method for producing an electronic apparatus for comparison;

FIGS. 15A and 15B are perspective views of a cutout portion of a frame according to a second embodiment;

FIGS. 16A and 16B are perspective views of a cover portion according to the second embodiment;

FIGS. 17A to 17C are views of a shape of a projection provided in the cover portion according to the second embodiment;

FIGS. 18A to 18D are schematic views of a fitting portion of the frame and the cover portion according to the second embodiment;

FIG. 19 is a flowchart of a process for adjusting a step generated in the fitting portion of the frame and the cover portion by providing a projection in the cover portion according to the second embodiment;

FIGS. 20A and 20B are schematic views of molds for producing the cover portion according to the second embodiment; and

FIG. 21 is a flowchart of a process for adjusting a step generated in the fitting portion of the frame and the cover portion by cutting an upper end of a projection of a cover portion according to a third embodiment.

### DESCRIPTION OF EMBODIMENTS

In the following, an embodiment will be described with reference to the drawings.

### First Embodiment

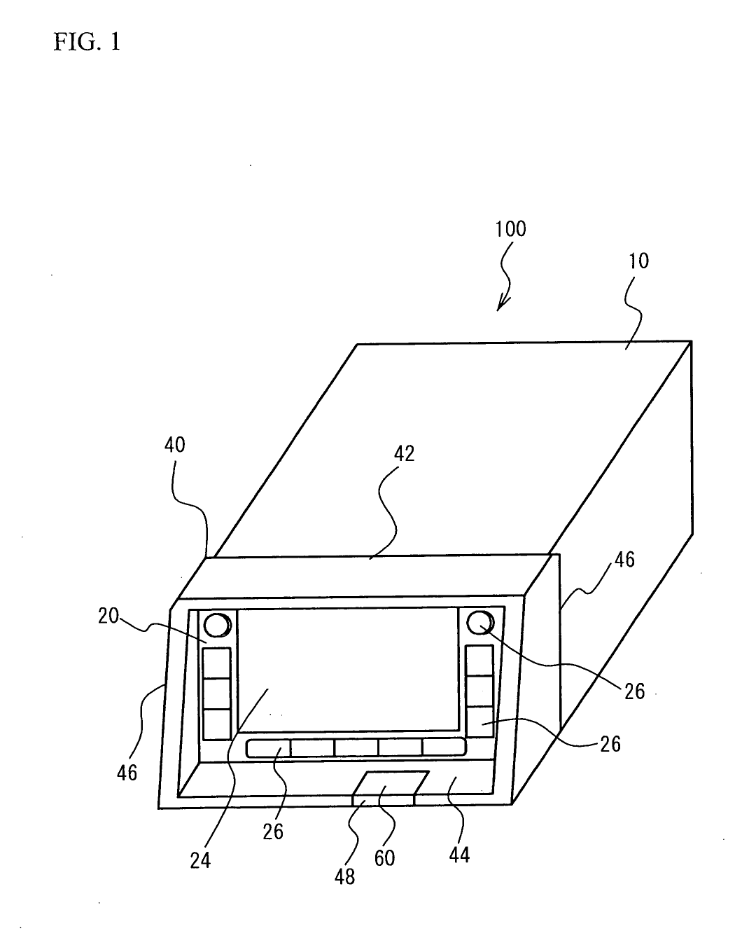

FIG. 1 is a perspective view of an electronic apparatus (car navigation apparatus) according to a first embodiment. Referring to FIG. 1, an electronic apparatus 100 has a main portion 10 and a display portion 20. The main portion 10 is equipped with a controller for car navigation, a player portion for a storage medium such as a CD (Compact Disc) and a DVD (Digital Versatile Disc), an audio, and the like. A frame 40 (inter panel) is provided at a front face of the main portion 10 to house the display portion 20 with covering the front face 12 of the main portion 10. The frame 40 has an upper portion 42, a lower portion 44, and side portions 46. The display portion 20 has a display screen 24 such as an LCD (Liquid Crystal Display), and an operational portion 26 for operating the display screen 24. Further, the display screen 24 may have a touch panel. A user is able to watch the display screen 24 when the display portion 20 is housed in the frame 40. The frame 40 is provided with a cutout portion 48 at the lower portion 44, and a cover portion 60 is fitted into the cutout portion 48. The cover portion 60 makes the cutout portion 48 inconspicuous to provide a good design.

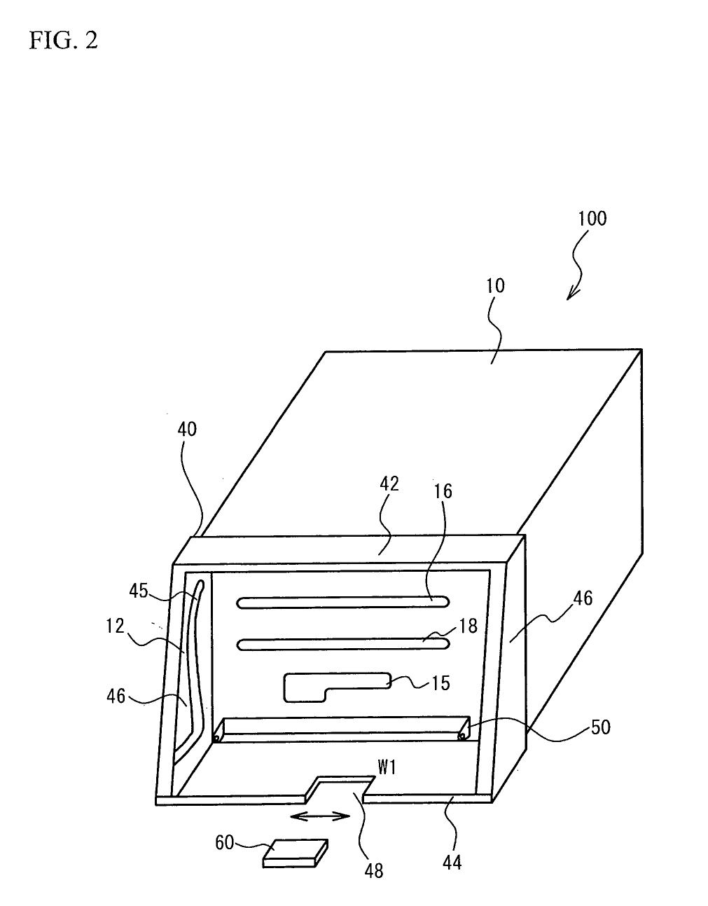

FIG. 2 is a perspective view of the main portion 10 from which the display portion 20 is detached. As illustrated in FIG. 2, an opening portion 15 for connecting the flexible substrate 30 is provided at the front face 12 of the main portion 10. A connector for connecting the flexible substrate 30 is provided within the opening portion 15. Further, an insertion and ejection slot 16 for a CD and an insertion and ejection slot 18 for a DVD are provided at an upper area of the front face 12 of the main portion 10. A slider 50 for tilting the display portion 20 is provided at the upper area of the front face 12 of the main portion 10. In the lower portion 44 of the frame 40, the cutout portion 48 is provided at a lower side of a position where the flexible substrate 30 is connected to the front face 12 of the main portion 10. FIG. 2 illustrates the state where the cover portion 60 is detached from the cutout portion 48. The guide grooves 45 are provided at inner surface of the right and left side portions 46 of the frame 40, is provided for tilting the display portion 20, and each has an S shape.

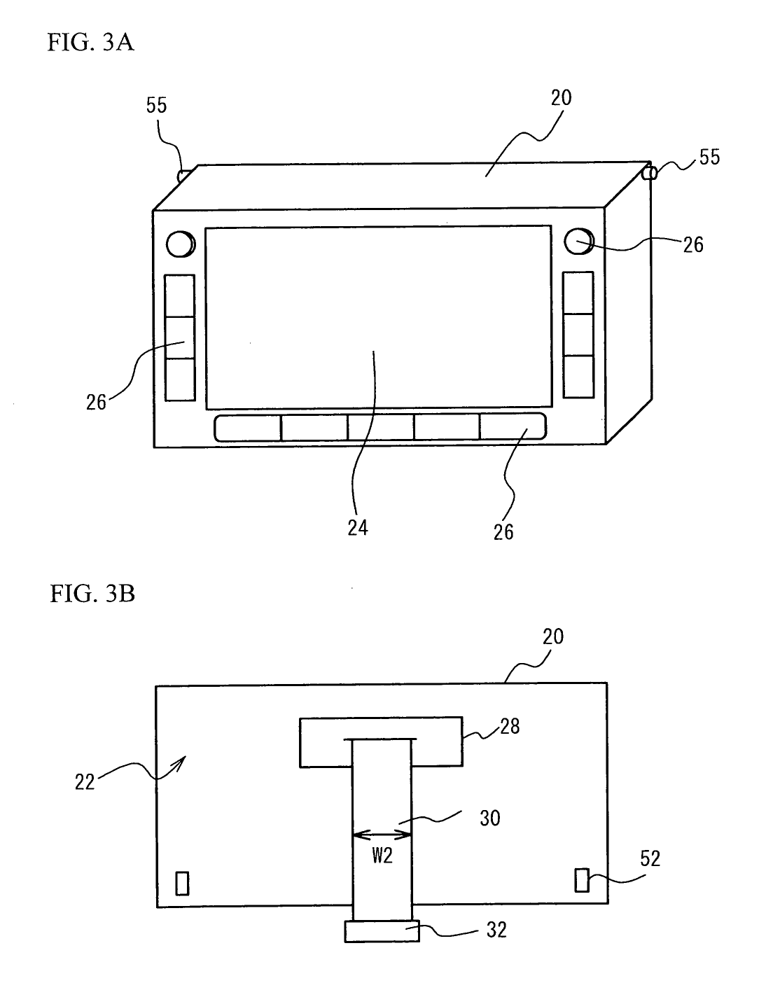

FIG. 3A is a view of the display portion 20. FIG. 3B is a view of a rear face 22 of the display portion 20. Referring to FIG. 3A, projections 55 are provided at its upper-rear face side of the side surfaces of the display portion 20. The projections 55 are respectively fitted into the guide grooves 45, and slide within the guide grooves 45 when the display portion 20 tilts. As illustrated in FIG. 3B, the flexible substrate 30 is mechanically connected to the rear face 22 of the display portion 20 by a connection portion 28. The flexible substrate 30 transmits an image signal for displaying an image on the display screen 24 from the main portion 10 to the display portion 20. Additionally, when the operational portion 26 of the display portion 20 is operated, the display portion 20 transmits the operational information to the main portion 10. A connector 32, which engages a connector 14 provided at the front face 12 of the main portion 10, is provided at an end of the flexible substrate 30. Connection portions 52 are provided for connecting the slider 50 at the right and the left of the low area of the rear face 22. The width W1 of the cutout portion 48 as illustrated in FIG. 2 is larger than the width W2 of the flexible substrate 30 as illustrated in FIG. 3B.

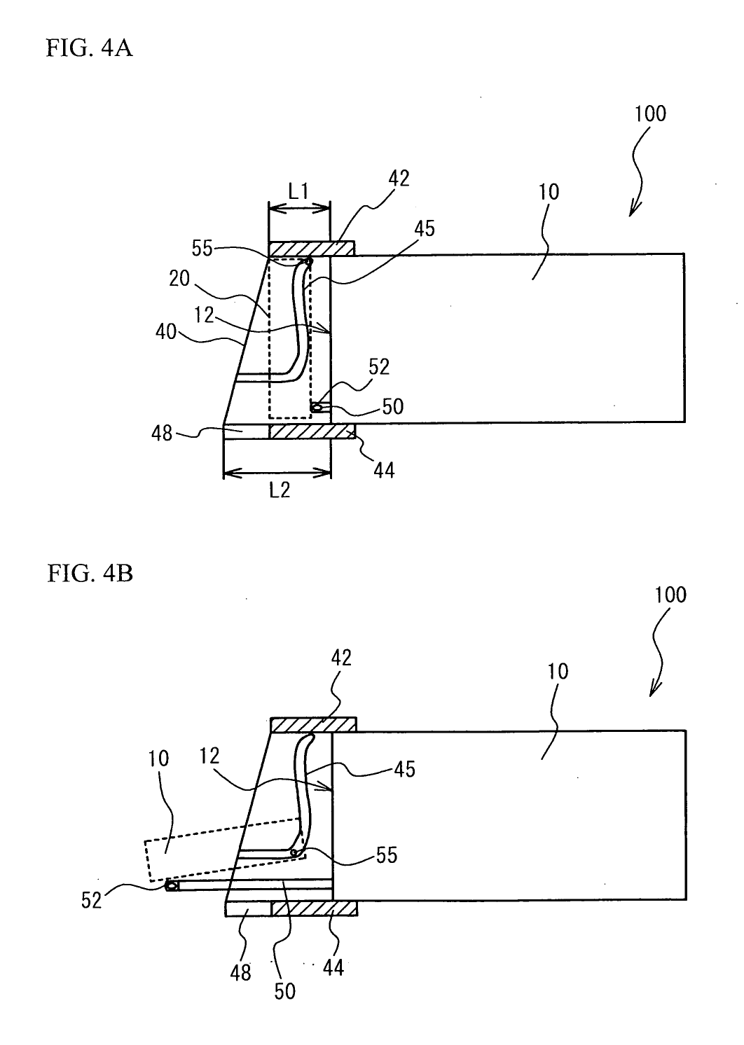

FIGS. 4A and 4B are cross-sectional views, of the electronic apparatus 100, for describing the movement of the display portion 20. The display portion 20 is indicated by a broken line. Referring now to FIG. 4A, a projection amount L2 of the lower portion 44 of the frame 40 projected from the front face 12 of the main portion 10 is greater than a projection amount L1 of the upper portion 42 projected from the front face 12 of the main portion 10. The projection 55 of the display portion 20 is fitted into the guide groove 45 of the frame 40. The end of the slider 50 is connected to the connection portion 52 on the rear face 22 of the display portion 20. The projection 55 is located at the upper end of the guide groove 45, when the display portion 20 covers the front face 12 of the main portion 10.

Referring now to FIG. 4B, when the front face 12 of the main portion 10 is exposed by moving the display portion 20, the slider 50 extends and the display portion 20 tilts to move its lower portion away from the main portion 10. At this time, the projection 55 slides within the guide groove 45. When the display portion 20 fully tilts and the front face 12 of the main portion 10 is fully exposed, the projection 55 is located at the lower end of the guide groove 45. In this state, the CD insertion and ejection slot and the DVD insertion and ejection slot provided on the front face 12 of the main portion 10 is operable. The flexible substrate 30 deforms, when the display portion 20 moves.

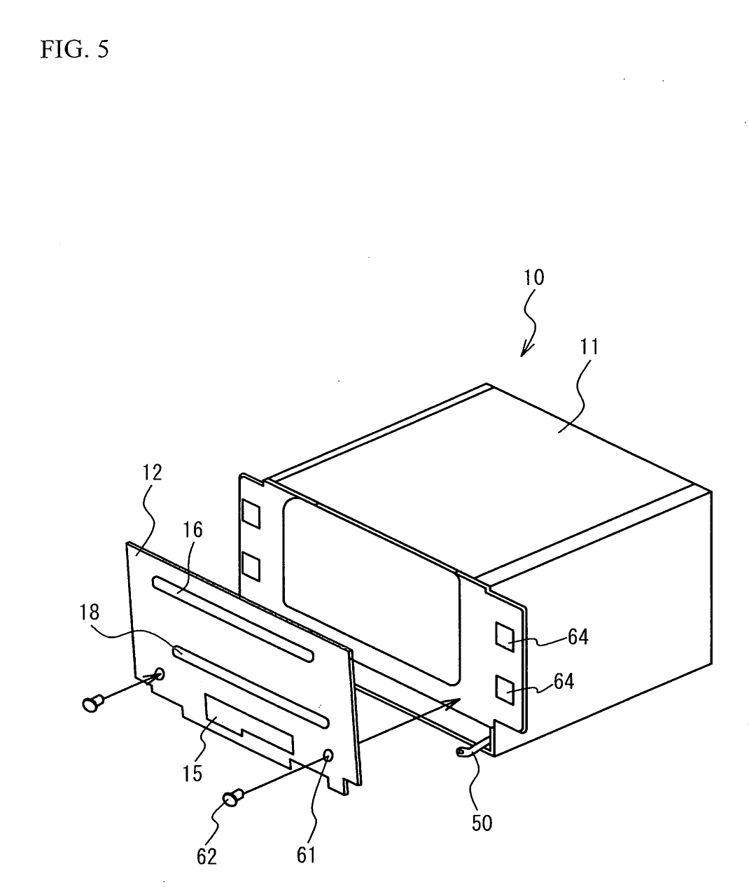

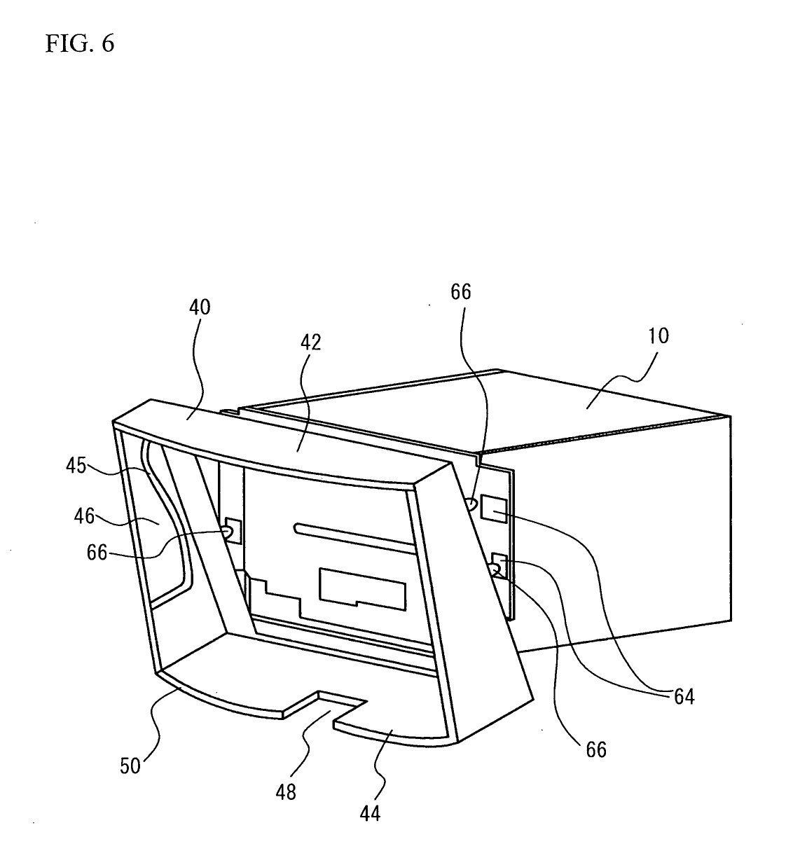

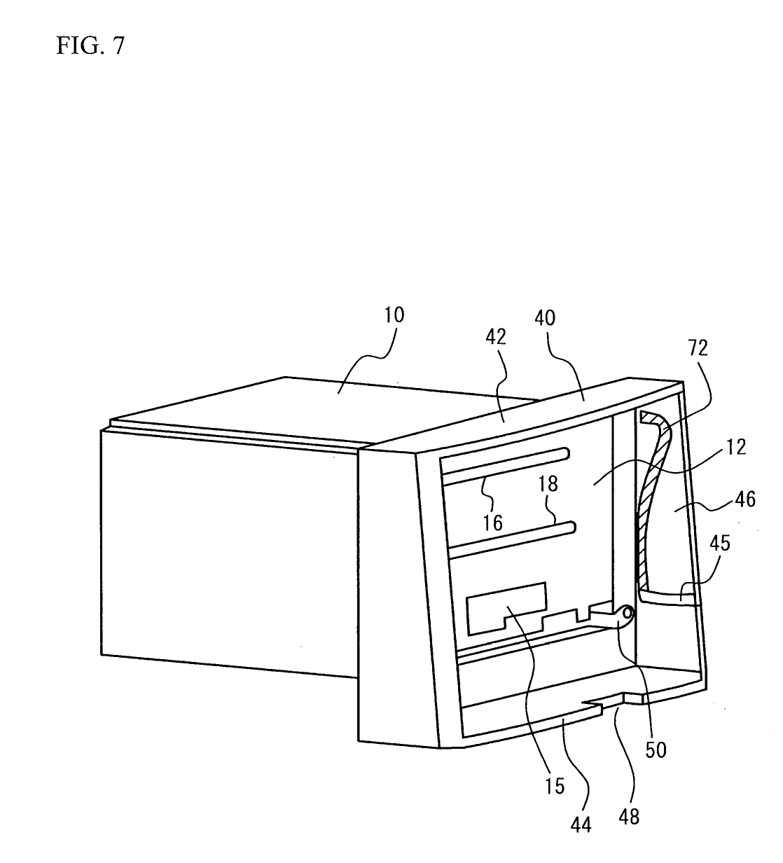

Next, a description will be given of a method for attaching the frame 40 and the display portion 20 to the main portion 10. FIGS. 5 to 13 are schematic views of the electronic apparatus 100. As illustrated in FIG. 5, a panel serving as the front face 12 is secured to a chassis 11 of the main portion 10 with screws 62 through screw holes 61. Thus, the main portion 10 is formed. Referring to FIG. 6, the frame 40 is assembled into the main portion 10 by fitting a fitting portion 66 into a fitting hole 64 of the main portion 10. As shown in FIG. 7, grease 72 is applied into the guide groove 45. The movements of the projections 55 within the guide grooves 45 are facilitated by the grease 72.

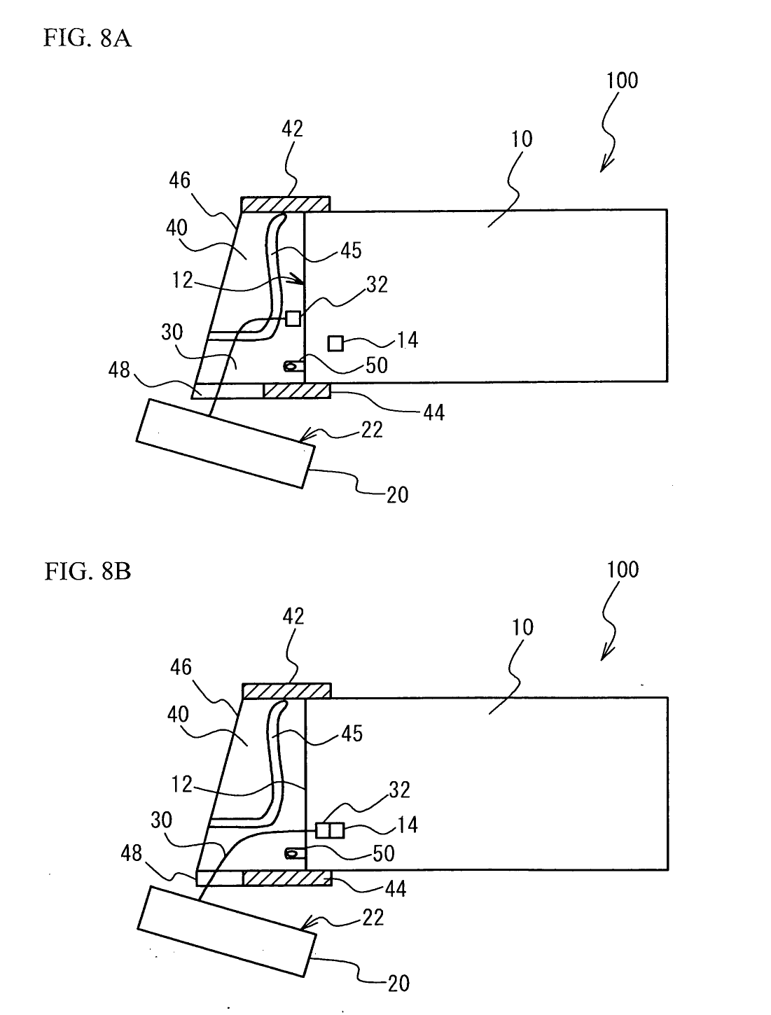

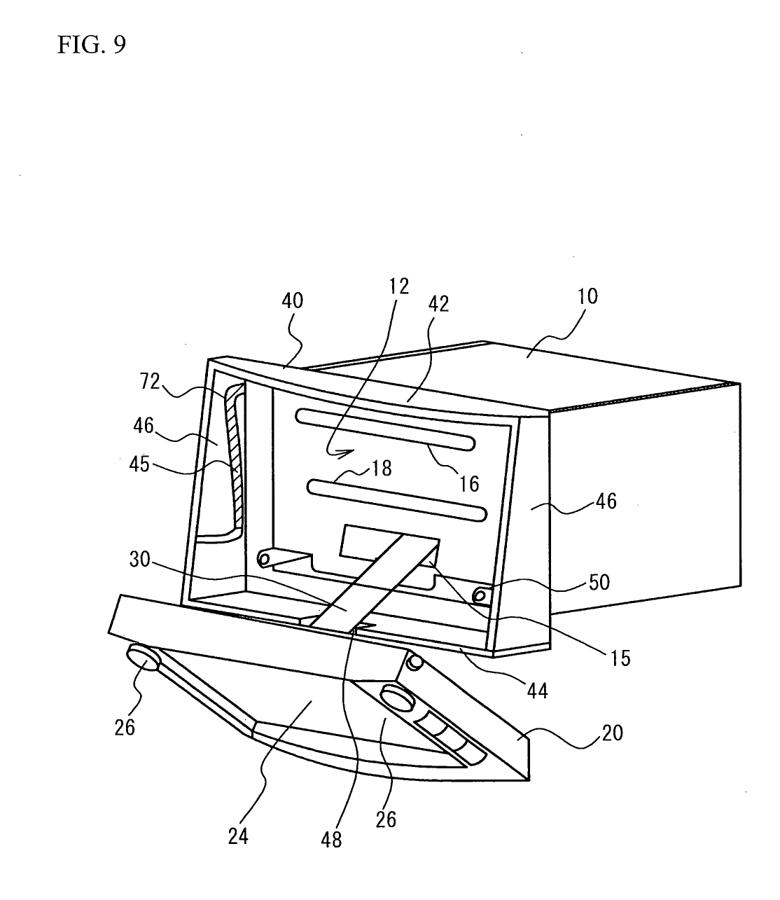

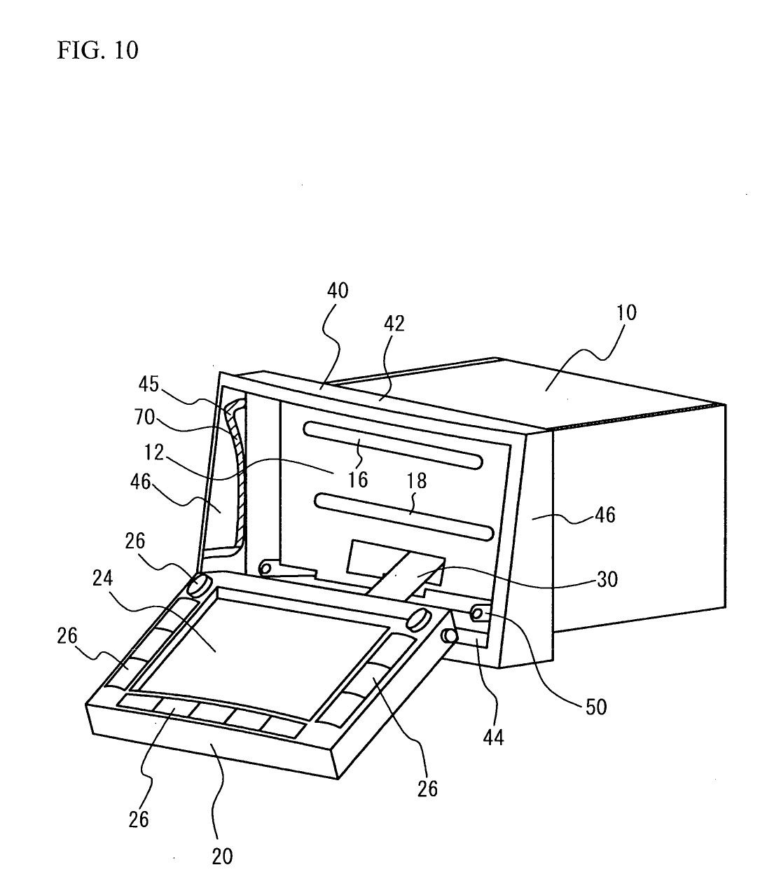

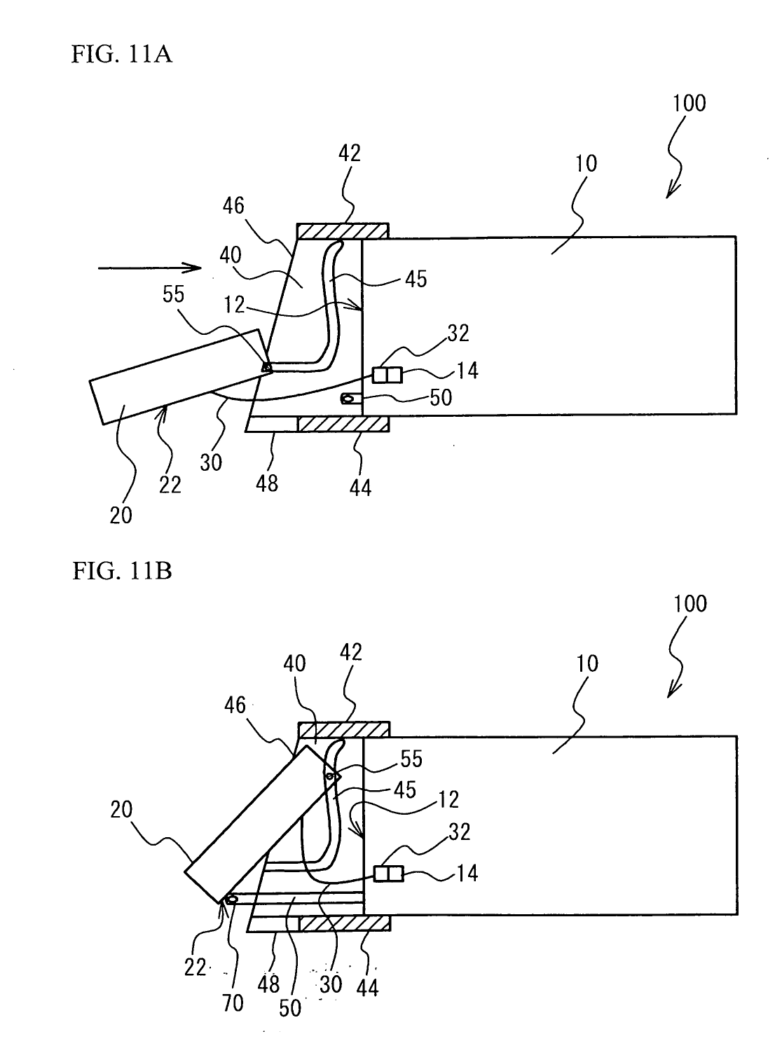

As illustrated in FIG. 8A, the display portion 20 is arranged at a lower side of the frame 40. Referring to FIGS. 8B and 9, the flexible substrate 30 is connected to the main portion 10 via the cutout portion 48. A connector 32 provided at the end of the flexible substrate 30 is fitted into the connector 14 via the opening portion 15. As illustrated in FIGS. 10 and 11A, the display portion 20 is arranged at the front side of the main portion 10. The display portion 20 is arranged such that its upper portion is close to the main portion 10 side and its lower portion is spaced apart from the main portion 10. The projection 55 of the display portion 20 is fitted into the guide groove 45. Since the guide groove 45 extends to the front face of the frame 40, the projection 55 can be fitted into the guide groove 45 with ease.

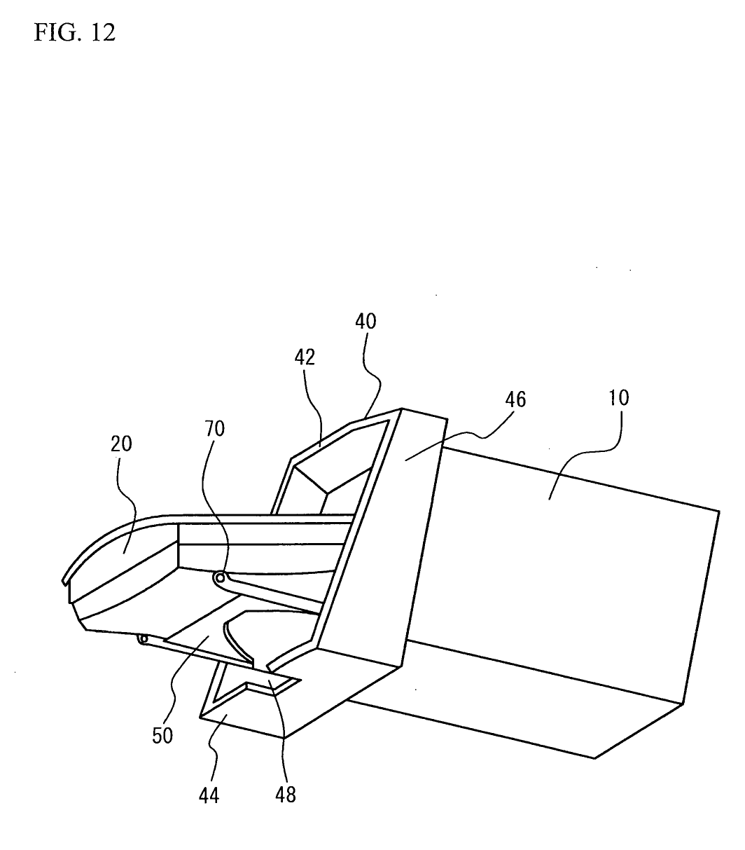

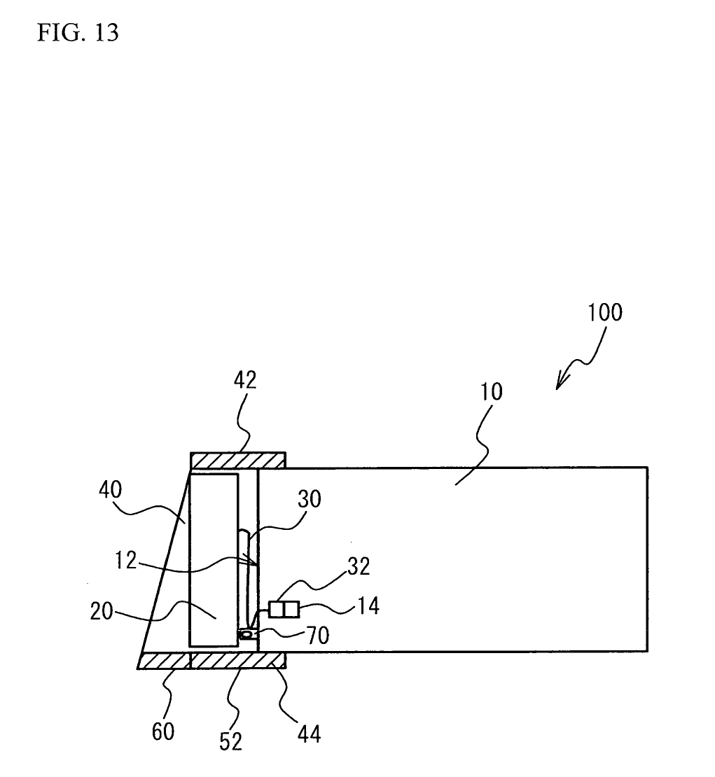

As illustrated in FIGS. 11B and 12, the slider 50 is extended to be connected to the connection portion 52 of the rear face 22 of the display portion 20. For example, the slider 50 is connected to the connection portion 52 by use of a screw 70. The slider 50 is rotatably connected to the connection portion 52 (referring to FIG. 3B). As illustrated in FIG. 13, the display portion 20 is raised. The cover portion 60 is fitted into the cutout portion 48. The frame 40 is secured to the main portion 10 with a screw. In this way, the attachment of the display portion 20 is accomplished.

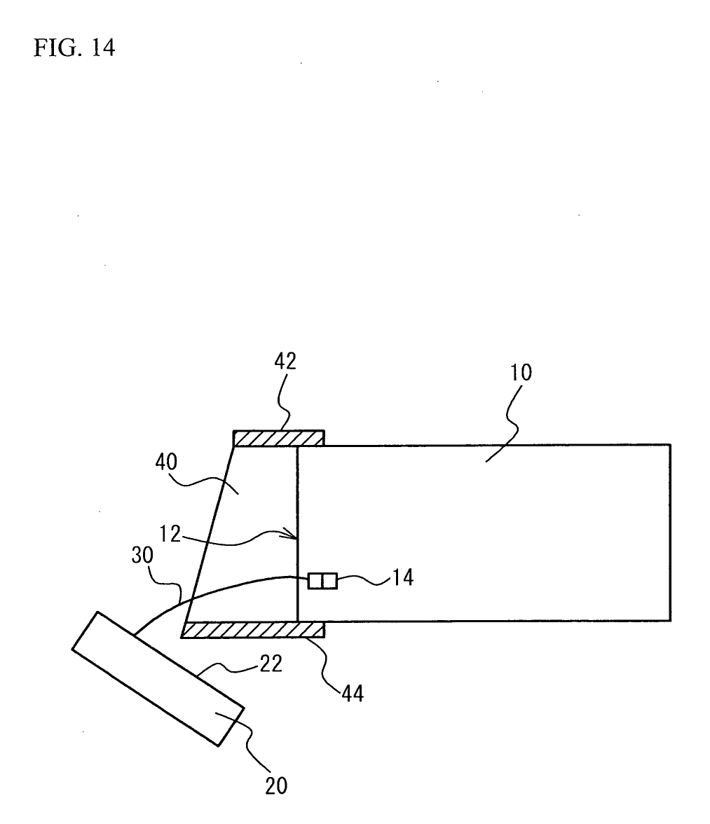

FIG. 14 is a view of a method for producing an electronic apparatus without the provision of the cutout portion 48 in the frame 40 for comparison (FIG. 14 corresponds to FIG. 8B of the first embodiment). When the flexible substrate 30 connected to the display portion 20 is connected to the front face 12 of the main portion 10 from the lower side of the lower portion 44, since the lower portion 44 is greatly projected, the flexible substrate 30 has to be made long. On the other hand, it is preferable that the flexible substrate 30 be short. When the flexible substrate 30 is short, it is difficult to produce the electronic apparatus.

In the first embodiment, the cutout portion 48 is provided at the lower portion 44 of the frame 40 at the lower side of the connector 14, to which the flexible substrate 30 is connected, of the front face 12 of the main portion 10, as illustrated in FIG. 2. Therefore, the flexible substrate 30 can be connected to the front face 12 of the main portion 10 via the cutout portion 48, as shown in FIG. 8B. Accordingly, it is possible to suppresses the interference of the connection of the flexible substrate 30 by the lower portion 44 of the frame 40. Consequently, even when the flexible substrate 30 is short, the electronic apparatus can be produced with ease.

In FIG. 8B, the reason why the display portion 20 is arranged lower than the frame 40 is that the flexible substrate 30 is connected to the connector 14 at the upper-front side of the front face 12 of the main portion 10 and that a space ensured for a worker's hands or a jig. In particularly, referring to FIG. 4B, in the electronic apparatus in which the display portion 20 tilts to move its lower portion away from the main portion 10, an operational portion such as the insertion and ejection slot for the disc medium is arranged at an upper area within the front face 12 of the main portion 10. Thus, the connector 14 is arranged at a lower area of the front face 12. In order to ensure a space for a worker's hand or a jig at an upper-front side of the front face 12, it is preferable to arrange the connector 14 lower than the frame 40 of the display portion 20 and to connect the flexible substrate 30 to the main portion 10.

It is preferable that the cutout portion 48 be wider than the flexible substrate 30. This guides the flexible substrate 30 into the cutout portion 48 with ease.

As illustrated in FIGS. 4A and 4B, the guide groove 45 is provided for guiding the projection 55, which is provided at the side portion 46 of the display portion 20, at the side portion 46 of the frame 40. The projection 55 is guided by the guide groove 45 to tilt the display portion 20. In a structure of such an electronic apparatus, it is preferable that the flexible substrate 30 be connected to the front face 12 of the main portion 10 via the cutout portion 48 as illustrated in FIG. 8B and that the projection 55 be then inserted to the side portion 46 as illustrated in FIG. 11A. This is because it is difficult to ensure the space for connecting the flexible substrate 30 to the connector 14 after the projection 55 is inserted into the guide groove 45.

The first embodiment exemplifies the in-vehicle electronic apparatus as an example of an electronic apparatus. An electronic apparatus may be a home electronic apparatus. Further, although the display portion has been described as an example of an electronic device, an electronic device may be any electronic device that covers the front face of the main portion and that moves with respect to the main portion to expose the front face thereof. In this case, the flexible substrate may transmit a signal such as data. Furthermore, the frame may house the entire display portion, or may house at least a part thereof.

### Second Embodiment

As described in the first embodiment, when the cutout portion 48 is provided in the frame 40, it is not preferable to keep the cutout portion 48 unchanged in consideration of the appearance of the frame 40. Hence, in order to improve the appearance of the frame 40, the cover portion 60 having a shape that mates a shape of the cutout portion 48 is fitted thereinto. At this time, the cover portion 60 is fitted into the cutout portion 48 such that a step is not generated in the fitting portion of the frame 40 and the cover portion 60, thereby further improving the appearance. However, there is a problem that it is difficult to produce the cover portion 60 with accuracy.

The following is a description of a second embodiment to overcome the above problem, with reference to the drawings.

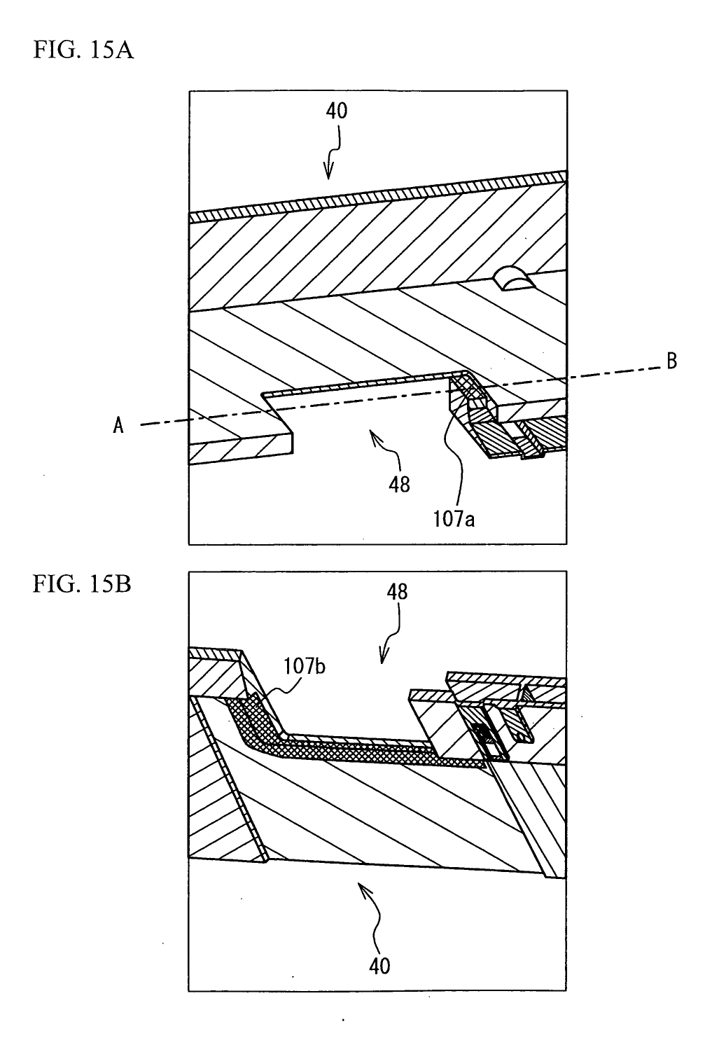

FIGS. 15A and 15B are perspective views of the lower portion of the frame 40 and enlarged views of the vicinity of the cutout portion 48. FIG. 15A illustrates the upper face of the lower portion of the frame 40. FIG. 15B illustrates the lower face of the lower portion of the frame 40.

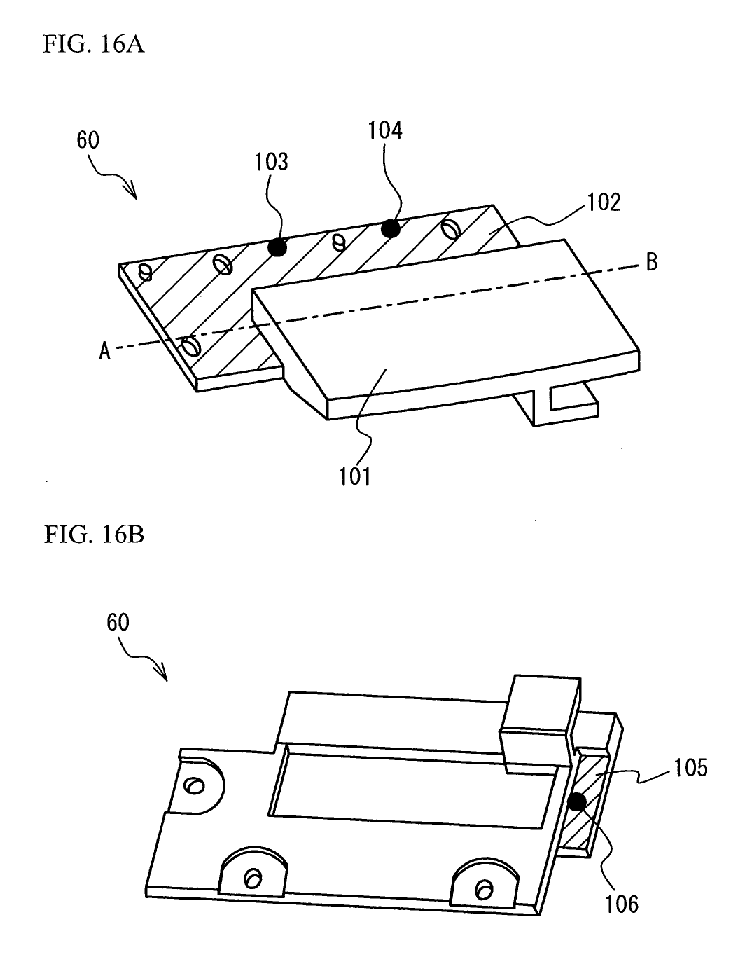

FIGS. 16A and 16B are perspective views for describing the shape of the cover portion 60. FIG. 16A illustrates the upper face of the cover portion 60. FIG. 16B illustrates the lower face of the cover portion 60.

Referring to FIG. 16A, a shape of a surface 101 matches that of the cutout portion 48. A surface 102 (a hatching section) comes into contact with a portion indicated by a numeral 107b of the frame 40 (a grid portion illustrated in FIG. 15B). Projections are provided on the surface 102 at positions indicated by black dots having numerals 103 and 104, and are provided for adjusting the step which is generated at the fitting portion of the frame 40 and the cover portion 60.

Referring to FIG. 16B, a surface 105 (hatching portion) comes into contact with a portion indicated by a numeral 107a of the frame 40 (a grid section illustrated in FIG. 15A). Like the positions denoted by numerals 103 and 104 in FIG. 16A, a projection is provided on the surface 105 at a position indicated by a black dot having a numeral 106.

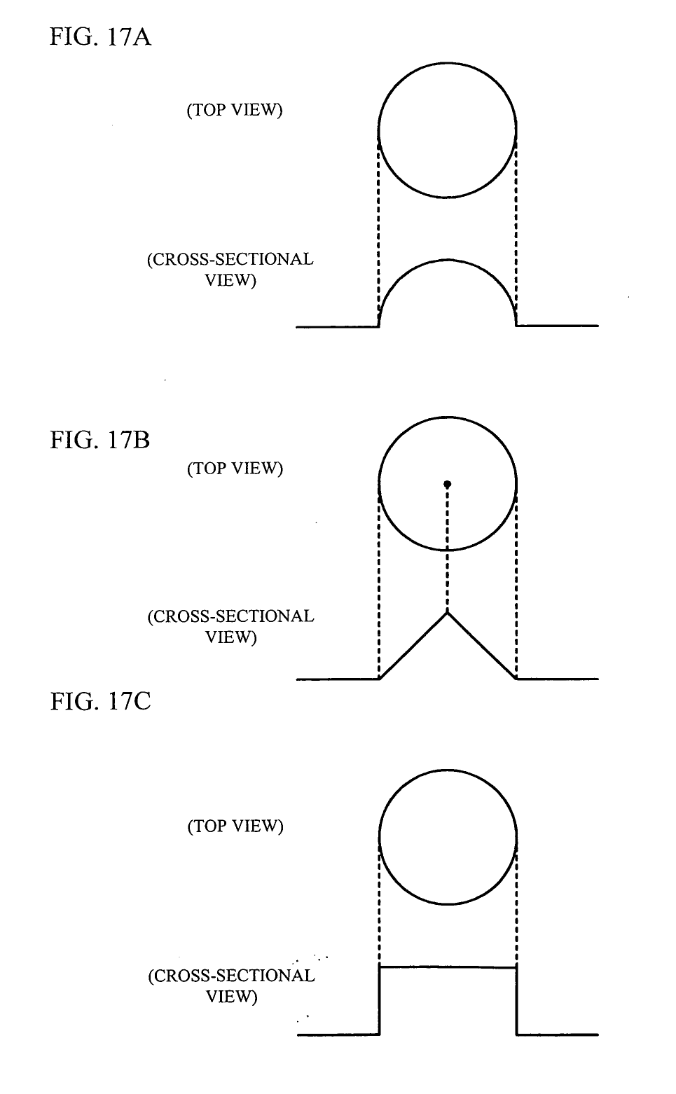

FIGS. 17A to 17C illustrate an example of each shape of the projections provided at the positions 103, 104 and 106 as illustrated in FIGS. 16A and 16B, and respectively illustrate an upper view and a cross-sectional view of the projection. The shape of the projection may be any one of a hemisphere, a circular cone, and a circular cylinder, as illustrated in FIGS. 17A to 17C.

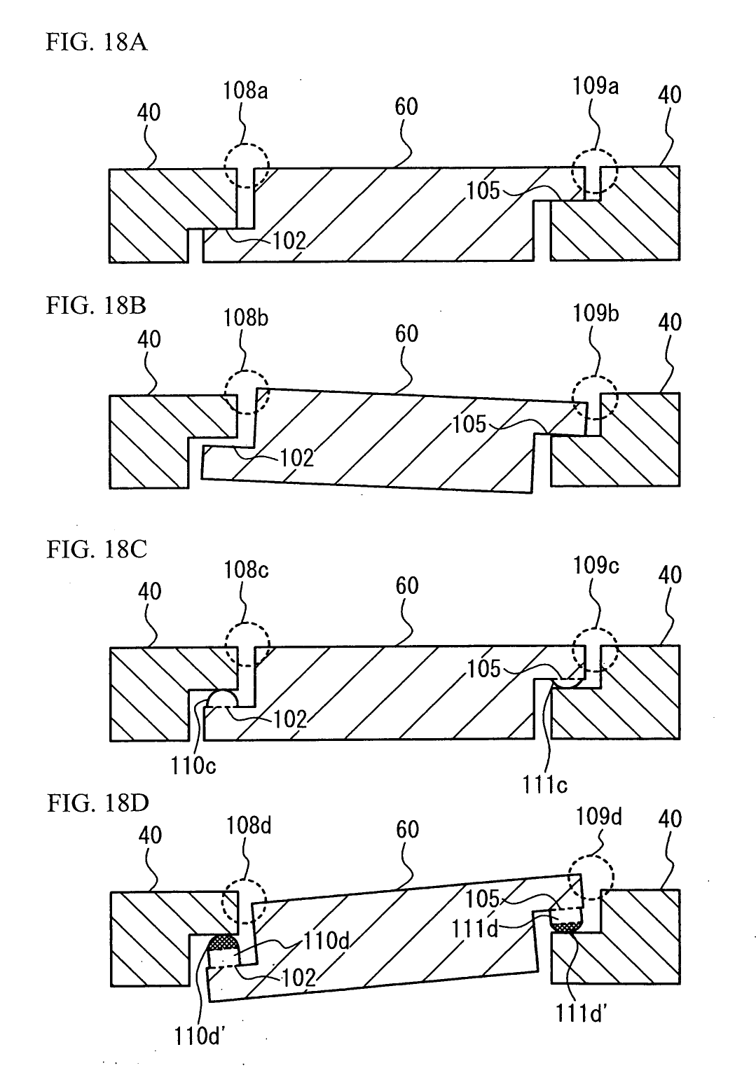

FIGS. 18A to 18D are schematic views of cross sections when the frame 40 is fitted in the cover portion 60, illustrate the cross section taken along the line A-B on the frame 40 in FIG. 15A and the cross section taken along the line A-B on the cover portion 60 in FIG. 16A.

FIG. 18A illustrates the state where a step is not generated in fitting portions 108a and 109a of the frame 40 and the cover portion 60. Referring to FIG. 18A, the front face of the cover portion 60 and that of the frame 40 are matched at the fitting portions 108a and 109a, and the step is not generated. The state where the step is not generated at the fitting portion means the state where the appearance of the fitting portion is not degraded in design. The surfaces 102 and 105 of the cover portion 60 are in contact with the frame 40.

FIG. 18B illustrates the state where the step is generated in fitting portions 108b and 109b of the frame 40 and the cover portion 60. Referring to FIG. 18B, since the front face of the cover portion 60 is higher than that of the frame 40 at the fitting portion 108b, the step is generated. The surface of the cover portion 60 is lower than that of the frame 40 at the fitting portion 109b, thereby generating the step. Such a step degrades the appearance in design.

FIG. 18C illustrates the state where the step is not generated in fitting portions 108c and 109c by providing projections 110c and 111c in the cover portion 60. Referring to FIG. 18C, the projections 110c and 111c are respectively provided at the surfaces 102 and 105 of the cover portion 60. The heights of the projections 110c and 111c are set not to generate the step illustrated in FIG. 18B at the fitting portions 108c and 109c. The step illustrated in FIG. 18B can be adjusted by the provision of the projections 110c and 111c such that the front face of the cover portion 60 and that of the frame 40 are matched in the fitting portions 108c and 109c. Accordingly, the appearance of the frame 40 can be improved.

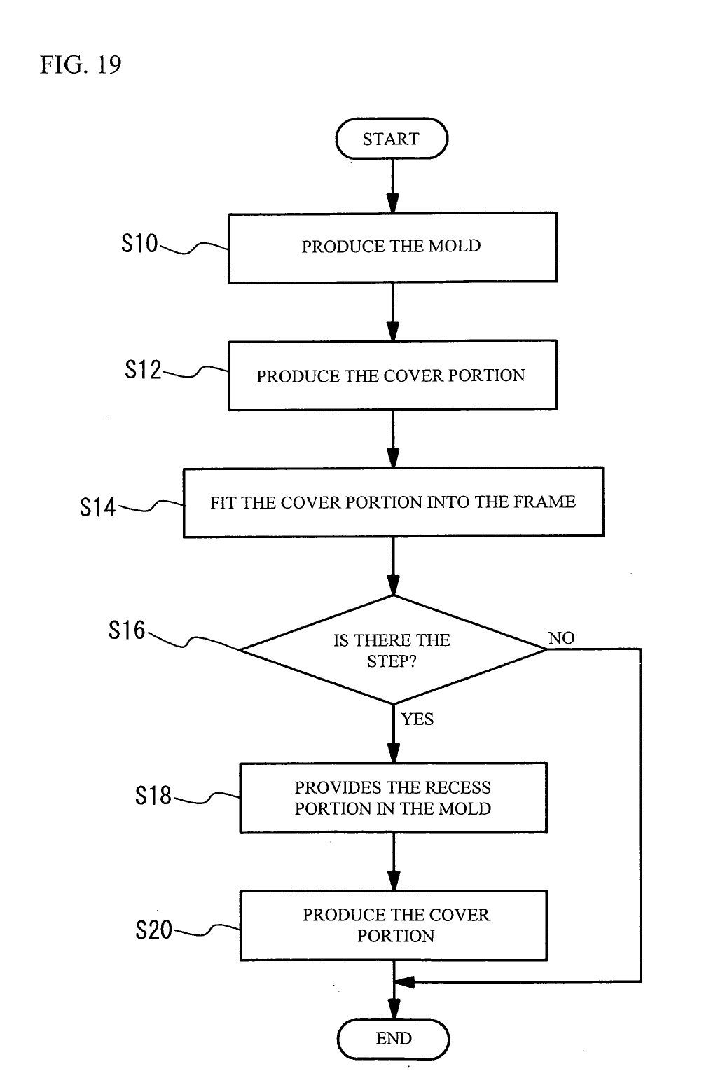

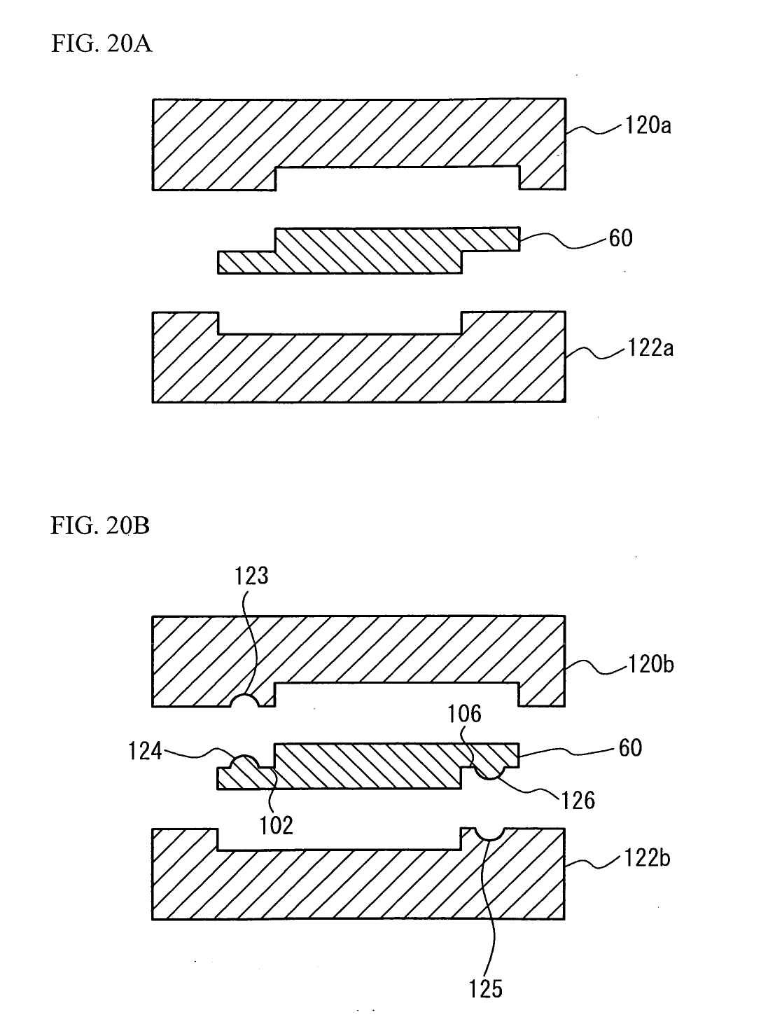

A description will be given of a process for adjusting the step generated in the fitting portion of the frame 40 and the cover portion 60, with reference to FIGS. 19, 20A and 20B. FIG. 19 is a flowchart of the process for adjusting the step generated in the fitting portion of the frame 40 and the cover portion 60. FIG. 20A is a schematic view illustrating an example of each of the cover portion and a cross section of molds for forming the cover portion. FIG. 20B is a schematic view illustrating an example of each of the cover portion provided with the projections and a cross section of molds having recess portions for providing the projections. The position of the cross section corresponds to that of the cross section taken along the A-B line in FIG. 16A.

Referring firstly to FIG. 19, the mold for producing the cover portion 60 is produced (step S10). FIG. 20A shows an example of the molds for producing the cover portion 60. Referring to FIG. 20A, a mold 120a corresponds to the upper face of the cover portion 60. A mold 122a corresponds to the lower face of the cover portion 60. The molds 120a and 122a will be described below as examples.

After step S10, the cover portion 60 is formed by the molds 120a and 122a (step S12). A material (such as ABS (acrylonitrile butadiene styrene) resin) is sandwiched between the molds 120a and 122a, and then they are pushed toward each other, thereby producing the cover portion 60.

After step S12, the cover portion 60 is fitted into the cutout portion 48 of the frame 40 (step S14). After step S14, whether or not there is a step in the fitting portion of the cover portion 60 and the frame 40 is determined (step S16). YES is determined in step S16, when the step is generated in the fitting portion of the cover portion 60 and the frame 40. For example, in the state as illustrated in FIG. 18B, YES is determined in step S16.

When YES is determined in step S16, the molds 120a and 122a are respectively provided with recess portions (step S18). FIG. 20B illustrates an example of cross-sections of the molds 120b and 122b which are respectively provided with recess portions. Referring now to FIG. 20B, the molds 120b and 122b are respectively provided with recess portions 123 and 125. The recess portion 123 is provided so as to form a projection 124 on the surface 102 of the cover portion 60. The recess portion 125 is provided so as to form the projection 126 on the surface 105 of the cover portion 60. When NO is determined in step S16, the process is finished.

After step S18, the cover portion 60 is produced by use of the molds 120b and 122b respectively provided with the recess portions 123 and 125 (step S20), and the process is finished. By step S20, the projections 124 and 126 can be respectively provided on the surfaces 102 and 105 of the cover portion 60. Therefore, for example, as illustrated in FIG. 18C, the step is adjustable such that the front surface of the cover portion 60 matches that of the frame 40. Accordingly, the appearance of the frame 40 can be improved.

In the second embodiment, as illustrated in FIGS. 16A and 16B, the electronic apparatus 100 has the projections at the surfaces 102 and 105 which come into contact with the frame 40, and has the cover portion 60 which is fitted into the cutout portion 48. Thus, the step, which is generated at the fitting portion of the frame 40 and the cover portion 60, is adjustable with ease. Consequently, the appearance of the frame 40 can be improved with ease.

It is preferable that the projection, for example, should have a dot shape as illustrated in FIGS. 17A and 17B (that is, the shape has a cross sectional area which is smaller toward its end, as illustrated in FIGS. 17A and 17B.). Thus, the expense of providing the recess portion in the mold in step S18 illustrated in FIG. 19 is saved, and the step is adjustable with ease. Therefore, the appearance of the frame 40 can be improved with ease.

In the second embodiment, the method for producing the electronic apparatus 100 includes the step of providing the projection at the surface of the cover portion 60 which comes into contact with the frame 40, in step S20 illustrated in FIG. 19. This makes adjustable the step which is generated in the fitting portion of the frame 40 and the cover portion 60. Thus, the appearance of the frame 40 can be improved.

In the second embodiment, the method for producing the electronic apparatus 100 includes the step of providing the recess portion in the mold for forming the cover portion 60 in step S18 illustrated in FIG. 19, when the step is generated in the fitting portion of the frame 40 and the cover portion 60 as the case of YES determined in step S16 in FIG. 19. The method for producing the electronic apparatus 100 further includes the step of providing the projection at the surface of the cover portion 60, which comes into contact with the frame 40, by use of the mold provided with the recess portion. Therefore, when the step is generated in the fitting portion of the frame 40 and the cover portion 60, the step can be adjusted with ease by providing the projection at the cover portion 60. Accordingly, the appearance of the frame 40 can be improved with ease.

In the second embodiment in FIG. 19, after step S20, the processing may return to step S16 to repeat step S16, S18, and S20.

With the method for adjusting the step by providing the projection in the cover portion 60, it is possible to reduce the number of the modified points of the mold, as compared with a case where the thickness of the surface contactable with the frame 40 is modified. Accordingly, this reduces a risk caused by the modification of the mold.

### Third Embodiment

In the third embodiment, the state of the step generated in the fitting portion of the frame 40 and the cover portion 60, and the method for adjusting the step are different from those of the second embodiment. In the following, the difference from the second embodiment will be described, and the similarity with the second embodiment will be omitted.

FIG. 18D illustrates the state where the step is generated in the fitting portion of the frame 40 and the cover portion 60 according to the third embodiment. Referring to FIG. 18D, since the projections 110c and 111c provided in the cover portion 60 are too high, the steps are generated in the fitting portions 108d and 109d. In the fitting portion 108d, since the projection 110d is too high, and the front surface of the cover portion 60 is lower than that of the frame 40, the step is generated. In the fitting portion 109d, the projection 111d is too high, and the front surface of the cover portion 60 is higher than that of the frame 40, so that the step is generated. In such a case, an upper end 110d′ (a grid section) of the projection 110d and an upper end 111d′ (a grid section) of the projection 111d are cut, thereby adjusting the heights of the projections 110d and 111d. This does not generate the step illustrated in FIG. 18C. Accordingly, the appearance of the frame 40 can be improved.

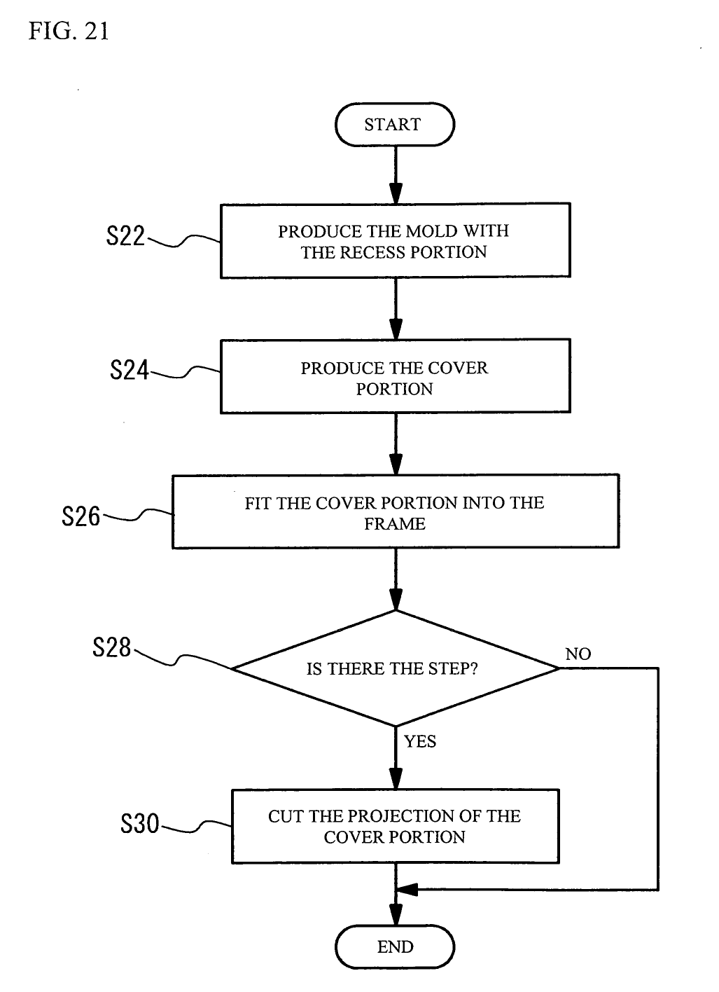

A description will be given of a process for adjusting the step generated as illustrated in FIG. 18D in the fitting portion of the frame 40 and the cover portion 60, with reference to FIGS. 20B and 21.

Referring to FIG. 21, the mold provided with the recess portion is produced (step S22). FIG. 20B illustrates an example of a mold provided with a recess portion. The description with reference to FIG. 20B is similar to that of the second embodiment, and will be omitted. The molds 120b and 122b will be described later as an example.

After step S22, the cover portion 60 is produced by use of the molds 120b and 122b which are respectively provided with the recess portions 123 and 125 (step S24). The surfaces 102 and 105 of the cover portion 60 are respectively provided with the projections 124 and 126 in step S24.

After step S24, the cover portion 60 is fitted into the cutout portion 48 of the frame 40 (step S26). After step S26, whether or not there is a step in the fitting portion of the cover portion 60 and the frame 40 is determined (step S28). YES is determined in step S28, when the step is generated in the fitting portion of the cover portion 60 and the frame 40. For example, in the state as illustrated in FIG. 18D, YES is determined in step S16.

When YES is determined in step S28, the upper ends of the projections 124 and 126 of the cover portion 60 are cut, so the process is then accomplished. This makes adjustable the step to, for example, match the front surface of the cover portion 60 with that of the frame 40, as illustrated in FIG. 18C. Thus, the appearance of the frame 40 can be improved.

In the third embodiment, the method for producing the electronic apparatus 100 includes the step of adjusting the step by cutting the upper end of the projection in step S30 in FIG. 21, when the step is generated in the fitting portion of the frame 40 and the cover portion 60 as illustrated in FIG. 18D, after the step of providing the projection in step S24 in FIG. 21. Thus, the step is adjustable with ease by cutting the upper end of the projection, when the step is generated in the fitting portion of the frame 40 and the cover portion 60, after the projection is provided in the cover portion 60. Accordingly, the appearance of the frame 40 can be improved.

In FIG. 21 of the third embodiment, after step S30, the processing may return to step S28 to repeat steps S28 and S30.

It is preferable that the projection has a dot shape (that is, a shape having a cross-sectional area which is smaller toward its end, as illustrated in FIGS. 17A and 17B). Thus, the expense of cutting the projection in step S30 is saved, and the step is adjustable with ease. Therefore, the appearance of the frame 40 can be improved with ease.

In the second and third embodiments, the in-vehicle electronic apparatus has been described as an example of the electronic apparatus. The electronic apparatus may be, for example, any home electronic apparatus.

The second and third embodiments exemplify the display portion which tilts. The display portion may be another electronic device. The display portion may be any display portion as far as it moves with respect to the main portion.

The second and third embodiments exemplify the flexible substrate which transmits the image signal for displaying the image on the image display from the main portion to the display portion. The image signal for displaying the image may be another kind of signal.

The second and third embodiments exemplify the frame, which is provided at the front face of the main portion to house the display portion covering the front face of the main portion. The frame may be provided at the front face of the main portion to house at least a part of the display portion covering the front face of the main portion.

By combining the flowchart according to the second embodiment illustrated in FIG. 19 and the flowchart according to the third embodiment illustrated in FIG. 21, the step, which is generated in the fitting portion of the frame and the cover portion, may be adjusted.

The present invention is not limited to the above-mentioned embodiment, and other embodiments, variations and modifications may be made without departing from the scope of the present invention.

What is claimed is:

1. An electronic apparatus comprising:
a main portion;
an electronic device which covers a front face of the main portion, and which moves with respect to the main portion to expose the front face of the main portion;
a flexible substrate which is connected between a rear face of the electronic device and the main portion, and which transmits a signal; and
a frame which is provided at the front face of the main portion to house at least a part of the electronic device when the electronic device covers the front face of the main portion, and in which a lower portion having a projection amount greater than that of an upper portion from the front face of the main portion, and which has a cutout portion which is lower than a position where the flexible substrate is connected to the front face of the main portion.

2. The electronic apparatus of claim 1, wherein the cutout portion is wider than the flexible substrate.

3. The electronic apparatus of claim 1, wherein the electronic device tilts to move a lower portion of the electronic device away from the main portion.

4. The electronic apparatus of claim 1, wherein a side portion of the frame is provided with a guide groove which guides a projection provided at a side portion of the electronic device to tilt the electronic device.

5. The electronic apparatus of claim 1, further comprising a member which is provided with a projection at its surface contactable with the frame, and which is fitted into the cutout portion.

6. The electronic apparatus of claim 5, wherein the projection has a dot shape.

7. The electronic apparatus of claim 1, wherein the electronic apparatus is an in-vehicle electronic apparatus.

8. A method for producing an electronic apparatus including: a main portion; an electronic device which covers a front face of the main portion, and which moves with respect to the main portion to expose the front face of the main portion; a flexible substrate which is connected between a rear face of the electronic device and the main portion, and which transmits a signal; and a frame which is provided at the front face of the main portion to house at least a part of the electronic device when the electronic device covers the front face of the main portion, and in which a lower portion having a projection amount greater than that of an upper portion from the front face of the main portion, and which has a cutout portion which is lower than a position where the flexible substrate is connected to the front face of the main portion,
the method comprising a step of connecting the flexible substrate connected to a rear face of the electronic device to a front face of the main portion via the cutout portion.

9. The method for producing an electronic apparatus of claim 8, further comprising a step of inserting a projection, which is provided at a side portion of the electronic device, to a guide groove, which is provided at a side portion of the frame and which guides the projection, after the step of connecting the flexible substrate to the front face of the main portion via the cutout portion.

10. The method of producing an electronic apparatus of claim 8, wherein the electronic device tilts to move its lower portion away from the main portion.

11. The method of producing an electronic apparatus of claim 8, wherein the electronic apparatus is an in-vehicle electronic apparatus.

12. A method for producing an electronic apparatus including: a main portion; an electronic device which covers a front face of the main portion, and which moves with respect to the main portion to expose the front face of the main portion; a flexible substrate that is connected between a rear face of the electronic device and the main portion, and which transmits a signal; a frame which is provided at the front face of the main portion to house at least a part of the electronic device when the electronic device covers the front face of the main portion, and in which a lower portion having a projection amount greater than that of an upper portion from the front face of the main portion, and which has a cutout portion which is lower than a position where the flexible substrate is connected to the front face of the main portion; and a member which is fitted into the cutout portion,
the method comprising a step of providing a projection at a surface of the member in contact with the frame.

13. The method for producing an electronic apparatus of claim 12, further comprising:
a step of providing a recess portion corresponding to the projection in a mold for producing the member, when a step is generated in a fitting portion of the frame and the member; and
a step of providing the projection at a surface of the member coming into contact with the frame by the mold provided with the recess portion.

14. The method for producing an electronic apparatus of claim 13, further comprising a step of adjusting the step by cutting an upper end of the projection, when the step is generated in the fitting portion of the frame and the member, after the step of providing the projection.

15. The method for producing an electronic apparatus of claim 12, wherein the projection has a dot shape.

16. The method for producing an electronic apparatus of claim 12, wherein the electronic apparatus is an in-vehicle electronic apparatus.
